(19) United States
(12) Patent Application Publication
(10) Pub. No.: US 2024/0020606 A1
(43) Pub. Date: Jan. 18, 2024

(54) COMPUTER-IMPLEMENTED SYSTEM AND METHOD FOR CREATING DYNAMIC WORKFLOWS TO ADDRESS THE NEEDS OF SUPPLY CHAIN

(71) Applicants: JAYA KRISHNA PARAGATI, Bangalore (IN); NAGARJUNA CHOWKILLA, Bangalore (IN); SREEDHAR KUMAR REDDY NARE, Bangalore (IN); SWIJANY CHILUKURI, Hyderabad (IN)

(72) Inventors: JAYA KRISHNA PARAGATI, Bangalore (IN); NAGARJUNA CHOWKILLA, Bangalore (IN); SREEDHAR KUMAR REDDY NARE, Bangalore (IN); SWIJANY CHILUKURI, Hyderabad (IN)

(21) Appl. No.: 17/865,753

(22) Filed: Jul. 15, 2022

(51) Int. Cl. G06Q 10/06; G06F 3/0486; G06F 40/174; G06F 40/143

(52) U.S. Cl. CPC G06Q 10/06316; G06F 3/0486; G06F 40/174; G06F 40/143

(57) ABSTRACT

A computer-implemented system for creating dynamic workflows to address the needs of a supply chain, comprising form designer enables first users to select drag and drop interfaces, set validations, and perform complex operations on first computing device, form designer creates dynamic forms based on the drag and drop interfaces. Workflow designer defines enterprise data and creates logical flow of data and actions, dynamic variable and dynamic workflows. Form designer and workflow designer transmits dynamic form designer configurations and dynamic workflow designer configurations to first database and business logic tool from first computing device. Business logic tool provides required forms to first users by retrieving dynamic form designer configurations, dynamic workflow designer configurations and form filled data stored in first database, business logic tool extracts enterprise data from second database to provide required forms to first users when required forms are not available in first database.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### TECHNICAL FIELD

The disclosed subject matter relates generally to a system and method for automating a business procedure. More particularly, the present disclosure relates to a computer-implemented system and method for creating dynamic workflows and enabling users to access enterprise data easily and address the needs of the supply chain.

### BACKGROUND

In general, to compete in today's business environment, business enterprises must have flexible systems and processes to respond to the needs of business users. Unfortunately, most business enterprises are slow to respond to internal problems and changes in business users' needs. Business enterprises use some business process management applications to improve business operational efficiency. As a result, the business solution adapts quickly to shifting market demands. In a typical business environment, each business requires distinct procedures that vary greatly based on its nature and type of business.

Existing systems offer a combination of dynamic forms and customizable workflow and focus more on the state of the document. Further, it is more generic like a Kanban board and lacks the integration of enterprise software like SAP Ariba. However, linear and rigid business process management solutions are challenging to alter after once developed and deployed. Changing the requirements of a business process management tool concerning the needs of business users is time-consuming and expensive. Hence, there is a need to develop a system by integrating SAP Ariba, and Coupa and making the enterprise data easily accessible to create dynamic workflows. In addition, there is a need to develop the system to address the needs of the supply chain with a complete Business Process Modeling Notation (BPMN) tool.

In the light of the aforementioned discussion, there exists a need for a certain system with novel methodologies that would overcome the above-mentioned challenges.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards a computer-implemented system that creates dynamic workflows to address the needs of the supply chain.

Another objective of the present disclosure is directed towards the system that enables the first users to access enterprise data easily.

Another objective of the present disclosure is directed towards the system that enables the first users to create a dynamic workflow using drag and drop interfaces.

Another objective of the present disclosure is directed towards the system that enables the second users to execute business transactions at scale using a workflow designer and a form designer, combined with a business logic tool to create dynamic applications on the fly.

Another objective of the present disclosure is directed towards the system customizes different reports for different groups of users.

Another objective of the present disclosure is directed towards the system that validates the insights presented to appeal to a user group.

Another objective of the present disclosure is directed towards the system that prompts the first users to perform quick actions resulting in better chances of increasing the success/profit earned from any changes implemented based on the decisions taken from these reports.

Another objective of the present disclosure is directed towards the system that detects a breach of a service level agreement (SLA) and triggers email notifications on a first computing device and/or a second computing device.

Another objective of the present disclosure is directed towards the system that creates attachments and conversations for a task.

Another objective of the present disclosure is directed towards the system that enables different users to collaborate by exchanging messages and documents.

Another objective of the present disclosure is directed towards the system that creates dynamic forms using the drag and drop interfaces, set validations, and allows to perform other complex operations.

Another objective of the present disclosure is directed towards the system that creates dynamic variable workflows using the drag and drop interfaces.

Another objective of the present disclosure is directed towards the system that facilitates adaptive monitoring and control of a business procedure.

Another objective of the present disclosure is directed towards the system that enables the first users to modify the business logic, user interface, and actions without changing any code.

Another objective of the present disclosure is directed towards the system that addresses the needs of supply chain trading partners by enabling the citizen developers or the business users to design, deploy, and execute trade workflows with a Business Process Modeling Notation (BPMN) tool to address extended and complex trading scenarios with variable due date and event triggers an alert mechanism including user interface and email notifications, multi-lingual, ready APIs integrated.

According to an exemplary aspect of the present disclosure, a first computing device includes a processor, a memory, and a dynamic workflow creation module, the processor coupled with the memory is configured to store the workflow creation module, the processor configured to respond to one or more user inputs performed by one or more first users on the first computing device.

According to another exemplary aspect of the present disclosure, the dynamic workflow creation module includes a form designer configured to enable the one or more first users to select one or more drag and drop interfaces, set validations, and perform one or more complex operations on the first computing device. In addition, the form designer is configured to create one or more dynamic forms based on the one or more drag and drop interfaces selected by the one or more users on the first computing device.

According to another exemplary aspect of the present disclosure, a workflow designer is configured to define enterprise data and create a logical flow of data and actions. The workflow designer is configured to create a dynamic variable and one or more dynamic workflows based on the one or more drag and drop interfaces selected by the one or more first users on the first computing device.

According to another exemplary aspect of the present disclosure, the form designer and the workflow designer are configured to export the one or more dynamic forms, the dynamic variable and the one or more dynamic workflows as one or more XML configurations, the one or more XML configurations comprises one or more dynamic form designer configurations and one or more dynamic workflow designer configurations.

According to another exemplary aspect of the present disclosure, the form designer and the workflow designer are configured to transmit the one or more dynamic form designer configurations and the one or more dynamic workflow designer configurations to a first database and a business logic tool from the first computing device over a network.

According to another exemplary aspect of the present disclosure, the first database is configured to store the one or more dynamic form designer configurations and the one or more dynamic workflow designer configurations.

According to another exemplary aspect of the present disclosure, the business logic tool is configured to receive the one or more dynamic form designer configurations, the one or more dynamic workflow designer configurations, and form-filled data from the form designer and the workflow designer.

According to another exemplary aspect of the present disclosure, the business logic tool is configured to transmit the one or more form designer configurations, one or more workflow configurations, and form-filled data to the first database and stores the one or more form designer configurations, the one or more workflow configurations and the form filled data.

According to another exemplary aspect of the present disclosure, the business logic tool is configured to provide one or more required forms to the one or more first users using the one or more form designer configurations, the one or more workflow configurations, and the form filled data is stored in the first database.

According to another exemplary aspect of the present disclosure, the business logic tool is configured to extract the enterprise data from a second database to provide the one or more required forms to the one or more first users when the one or more required forms are not available in the first database.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram depicting a schematic representation of a system for creating dynamic workflows to address the needs of the supply chain, in accordance with one or more exemplary embodiments.

FIG. 2 is a block diagram depicting an embodiment of the dynamic workflow creation module 108 shown in FIG. 1, in accordance with one or more exemplary embodiments.

FIG. 3A is an example screen depicting a settings screen, in accordance with one or more exemplary embodiments.

FIG. 3B is an example screen depicting a data visibility tags screen, in accordance with one or more exemplary embodiments.

FIG. 3C is an example screen depicting forms associated with the dynamic workflow creation module 108 screen, in accordance with one or more exemplary embodiments.

FIG. 3D is an example screen depicting a form configuration screen, in accordance with one or more exemplary embodiments.

FIG. 3E is an example screen depicting a form designer screen, in accordance with one or more exemplary embodiments.

FIG. 3F is an example screen depicting a SLA (service-level agreement) definition screen, in accordance with one or more exemplary embodiments.

FIG. 3G is an example screen depicting a workflow designer screen, in accordance with one or more exemplary embodiments.

FIG. 4 is an example diagram depicting a workflow of the dynamic workflow creation module, in accordance with one or more exemplary embodiments.

FIG. 5 is a flow diagram depicting a method for creating dynamic workflows to address the needs of the supply chain, in accordance with one or more exemplary embodiments.

FIG. 6 is a flow diagram depicting a method for creating dynamic workflows, in accordance with one or more exemplary embodiments.

FIG. 7 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

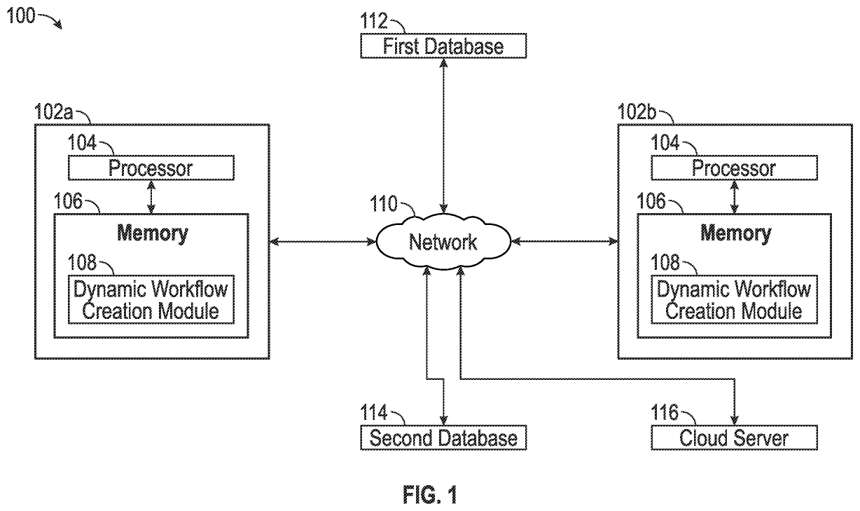

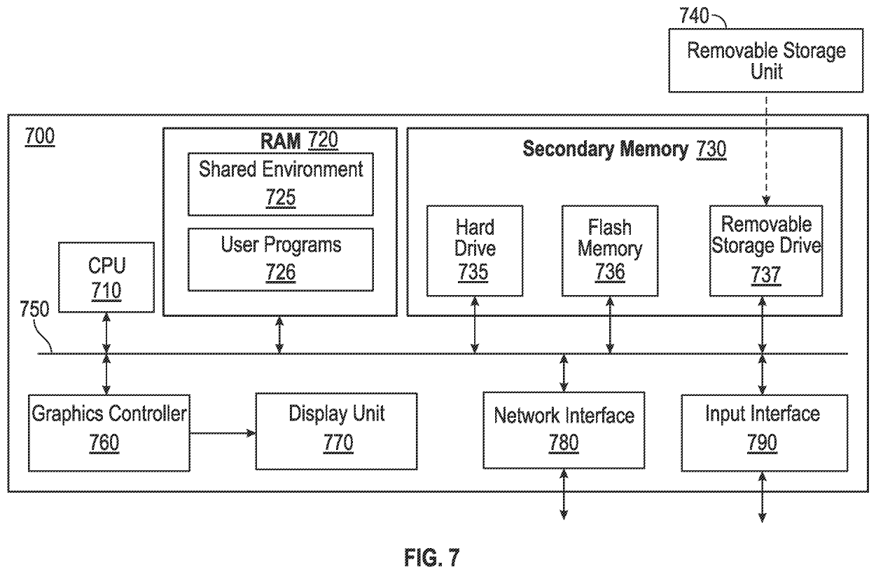

Referring to FIG. 1 is a block diagram 100 depicting a schematic representation of a system for creating dynamic forms and dynamic workflows to address the needs of the supply chain, in accordance with one or more exemplary embodiments. The system 100 includes. The system 100 includes a first computing device 102a, a second computing device 102b, a network 110, a first database 112, a second database 114, and a cloud server 116. The computing devices 102a and 102b include a processor 104, a memory 106, and a dynamic workflow creation module 108. The processor 104 includes the memory 106 may be configured to store the dynamic workflow creation module 108 on the first computing device 102a. The processor 104 may be a central processing unit and/or a graphics processing unit (As shown in FIG. 7). The computing devices 102a or 102b may be connected to one or more computing devices over the network 110. The term “module” is used broadly herein and generally refers to a program resident in the memory of the computing devices 102a and 102b. The cloud server 116 includes the dynamic workflow creation module 108 may be configured to enable the first users to access the enterprise data easily on the first computing device 102a. The enterprise data may include, but is not limited to, Enterprise Master data (Business Organizations, Plants, User groups, Users and the like), Manufacturing data, Raw material data, Supplier Data, Distribution data, Retail data, Customer Data and the like. The cloud server 116 includes the dynamic workflow creation module 108 may be configured to create the dynamic workflows to automate the business process and address the needs of the supply chain. The first computing device 102a and the second computing device 102b may include the dynamic workflow creation module 108 configured to create the dynamic workflows to automate the business process and address the needs of the supply chain. The first computing device 102a may be operated by the first users. The first users may include, but are not limited to, citizen developers, business users, participants, organizations, and the like. The second computing device 102b may be operated by the second user. The second user may include, but is not limited to, trading partners, supply chain trading partners, and the like.

The dynamic workflow creation module 108 may be configured to enable the second user to execute business transactions at scale on the second computing device 102b over the network 110. The network 110 may include, but not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and the like without limiting the scope of the present disclosure. The network 110 may be configured to provide access to different types of users. The computing devices 102a and 102b may include, but is not limited to, a personal digital assistant, smartphones, personal computers, a mobile station, computing tablets, a handheld device, an internet enabled calling device, an internet enabled calling software, a telephone, a mobile phone, a digital processing system, and the like.

The dynamic workflow creation module 108 is accessed as a mobile application, web application, software that offers the functionality of accessing mobile applications, and viewing/processing of interactive pages, for example, are implemented in the computing devices 102a and/or 102b, as will be apparent to one skilled in the relevant arts by reading the disclosure provided herein. For example, the dynamic workflow creation module 108 may be any suitable application downloaded from GOOGLE PLAY® (for Google Android devices), Apple Inc.'s APP STORE® (for Apple devices), or any other unified database. The dynamic workflow creation module 108 may be a desktop application that runs on Mac OS, Microsoft Windows, Linux, or any other operating system that may be downloaded from a webpage or a CD/USB stick and the like. In some embodiments, the dynamic workflow creation module 108 may be software, firmware, or hardware that is integrated into the computing devices 102a and/or 102b. The computing devices 102a and/or 102b, may present a web page to the first users/second users by way of a browser, wherein the webpage comprises a hyper-link that may direct the user to a uniform resource locator (URL).

Although the computing devices 102a/102b are shown in FIG. 1, an embodiment of the system 100 may support any number of computing devices. The computing devices 102a/102b may be operated by the first users/second users or programmatically via pre-configured application logic. The computing devices 102a/102b supported by the system 100 is realized as computer-implemented or computer-based device having the hardware or firmware, software, and/or processing logic needed to carry out the computer-implemented methodologies described in more detail herein. System 100 intends to create dynamic workflows to automate the business process and address the needs of the supply chain.

The first database 112 may be a configuration database configured to hold the dynamic form designer configurations and dynamic workflow designer configurations. The dynamic form designer configurations may be in JSON or XML format, and the dynamic workflow designer configurations may be in RJSON or BSON format. The second database 114 may be configured to locate the external data generated by other systems(external data sources) or the dynamic workflow creation module 108. For example, the second database 114 includes external data sources and external application programming interfaces. The external data sources may include, but are not limited to, any data source from the enterprises (SAP Ariba, Coupa, Salesforce, and the like) or publicly available data, weather, traffic, and the like. The cloud server 116 may be configured to store the dynamic workflows and dynamic forms created by the dynamic workflow creation module 108 on the first computing device 102a and/or the second computing device 102b.

The dynamic workflow creation module 108 may be configured to enable the first users to design, deploy, and execute trade workflows with a business process modeling notation (BPMN) tool to address the needs of the second users. The dynamic workflow creation module 108 may be configured to address the extended and complex trading scenarios with variable due dates, event triggers, and alert mechanisms. Examples of extended and complex trading scenarios are supply chain issue management, Product Transitions, Shipping Calendars, Part sourcing attributes, Shipping Lanes, and the like. The event triggers an alert mechanism that may include, but is not limited to, messages, SMS, and email notifications, multi-lingual, ready APIs integrated.

The dynamic workflow creation module 108 may be configured to access the enterprise data easily from the second database 114 to create the dynamic workflows. The enterprise data may include, but is not limited to, Enterprise Master data (Business Organizations, Plants, User groups, Users, and the like), Manufacturing data, Raw material data, Supplier Data, Distribution data, Retail data, Customer Data and the like. The dynamic workflow creation module 108 may be configured to enable the first users to modify and deploy the business workflows as per changing business needs without any internal code changes. The dynamic workflow creation module 108 may be configured to enable the second users participating in global multi-organizations and wholistic supply chain, to execute a comprehensive workflow with due dates and are visible, editable at field level, attachment level, and document level.

The dynamic workflow creation module 108 may be configured to perform an intelligent enterprise alliance and realize the trading partner's business logic via form and workflow configurations, eventually making the enterprise data available from the different data sources and managing the flow of data for alliance execution. The data may be in any format based on the data source and retrieval mechanism. The data retrieved from the external/internal database 112/114 may be in SQL results format. The data retrieved from the web applications may be in JSON or XML format. The documents may be in Word, PPT, PDF, CSV, and the like. The dynamic workflow creation module 108 may be configured to create attachments and conversations for a task, where the different first users collaborate, exchanging messages and documents. The conversations may include the text messages between the first and second users involved in a task. Text messages may be exchanged between the supplier, buyer accounts user, third-party quality auditor, and the like. As part of the conversations, the dynamic workflow creation module 108 may be configured to enable the first and second users to exchange files by attaching files to the conversation message on the first computing device 102a and the second computing device 102b. The dynamic workflow creation module 108 may be configured to allocate tags for the data visibility of form fields/attachments/conversation messages and the like.

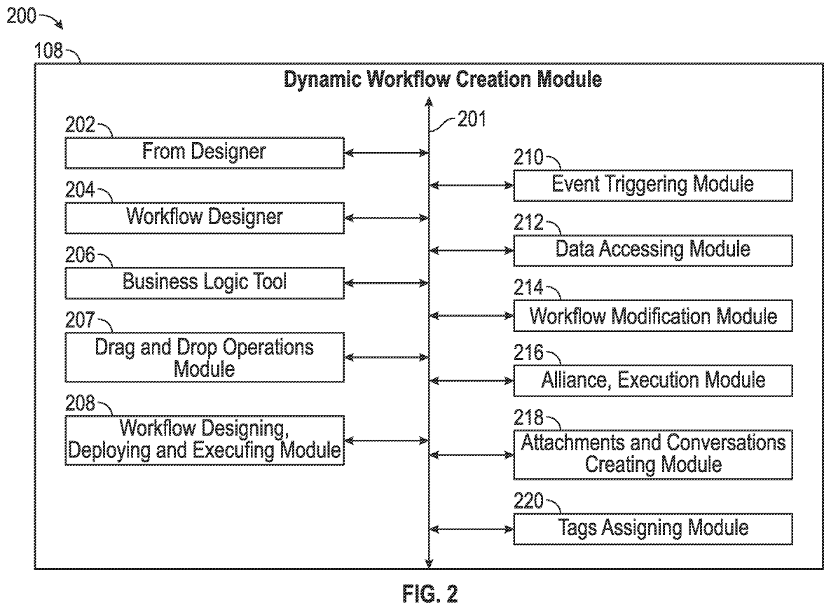

Referring to FIG. 2 is a block diagram 200 depicting an embodiment of the dynamic workflow creation module 108 shown in FIG. 1, in accordance with one or more exemplary embodiments. The dynamic workflow creation module 108 includes a bus 201, a form designer 202, a workflow designer 204, a business logic tool 206, drag and drop operations module 207, a workflow designing, deploying, and executing module 208, an event triggering module 210, a data accessing module 212, a workflow modification module 214, an alliance execution module 216, an attachments and conversations creating module 218, and tags assigning module 220.

The bus may include a path that permits communication among the modules of the dynamic workflow creation module 108 installed on the first and second computing devices 102a and 102b. The term “module” is used broadly herein and refers generally to a program resident in the memory of the first and second computing devices 102a and 102b. The dynamic workflow creation module 108 may be configured to retrieve the dynamic workflow designer configurations and the dynamic form designer configurations from the first database 112 and renders the required forms to the first users. The forms may be with inputs like Text fields, Text area, Drop downs(Single and multiple select), and the like, which can be rendered on the first computing device 102a and the second computing device 102b. The modified form data may be submitted back to the cloud server 116 and is persisted in the first database 112. The dynamic workflow creation module 108 may be a central portal for process automation to allow the second users to execute business transactions at scale.

In accordance with one or more exemplary embodiments of the present disclosure, the form designer 202 may be configured to create web-based forms with HTMLS UI elements. The form designer 202 may be configured to create dynamic forms based on the drag and drop interfaces, validations, and other complex operations. The form designer 202 may be configured to export the created dynamic forms as an XML or JSON configuration (dynamic form designer configuration) and the exported dynamic form designer configuration is persisted in the first database 112. The workflow designer 204 may be configured to define the enterprise data and create a logical flow of data and actions. The workflow designer 204 may be configured to create dynamic variables and workflow using drag and drop interfaces. The workflow designer 204 may be configured to export the created dynamic workflow as an XML or JSON configuration (dynamic workflow designer configuration), and the exported dynamic workflow designer configuration is persisted in the first database 112.

In accordance with one or more exemplary embodiments of the present disclosure, the business logic tool 206 is a business process modeling notation (BPMN) tool that is intelligent in obtaining the enterprise data available from different data sources and manages the flow of data. The business logic tool 206 may be configured to receive the dynamic form designer configurations, the dynamic workflow designer configurations, and the form-filled data and persists in the first database 112. The business logic tool 206 may be configured to extract the enterprise data from the second database 120 (external sources) and provides the required forms to the first users.

The drag and drop operations module 207 may be configured to enable the first users to select the required drag and drop interfaces to create the dynamic workflow. The workflow designing, deploying, and executing module 208 may be configured to enable the first users to design, deploy, and execute trade workflows with the business process modeling notation tool to address the needs of the second users. The event triggering module 210 may be configured to address the extended and complex trading scenarios with variable due date, event triggers and alert mechanisms. The event triggers and alert mechanisms may include, but not limited to, messages, SMS, and email notifications, multi lingual, ready APIs integrated.

In accordance with one or more exemplary embodiments of the present disclosure, the data accessing module 212 may be configured to access the enterprise data easily from the second database 114 to create the dynamic workflows. The data accessing module 212 may be configured to access the external data from the second database 114. The workflows modification module 214 may be configured to enable the first users to modify and deploy the business workflows as per changing business needs without any internal code changes. The alliance execution module 216 may be configured to perform intelligent enterprise alliances and realizes the trading partner's business logic through the dynamic workflow designer configurations and the dynamic form designer configurations. The alliance execution module 216 may eventually make the enterprise data available from the different data sources and manages the flow of data for the alliance execution. The attachments and conversations creating module 218 may be configured to create attachments and conversations for a task, where the different first users collaborate, exchanging messages and documents. The tags allocating module 220 may be configured to allocate tags for the data visibility of form fields/attachments/conversation messages and the like.

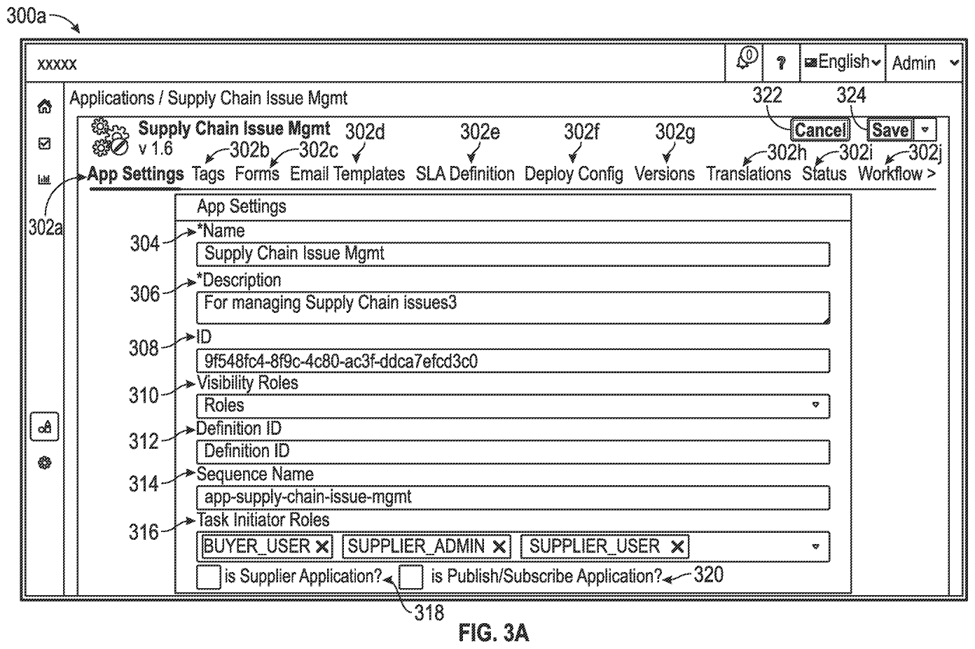

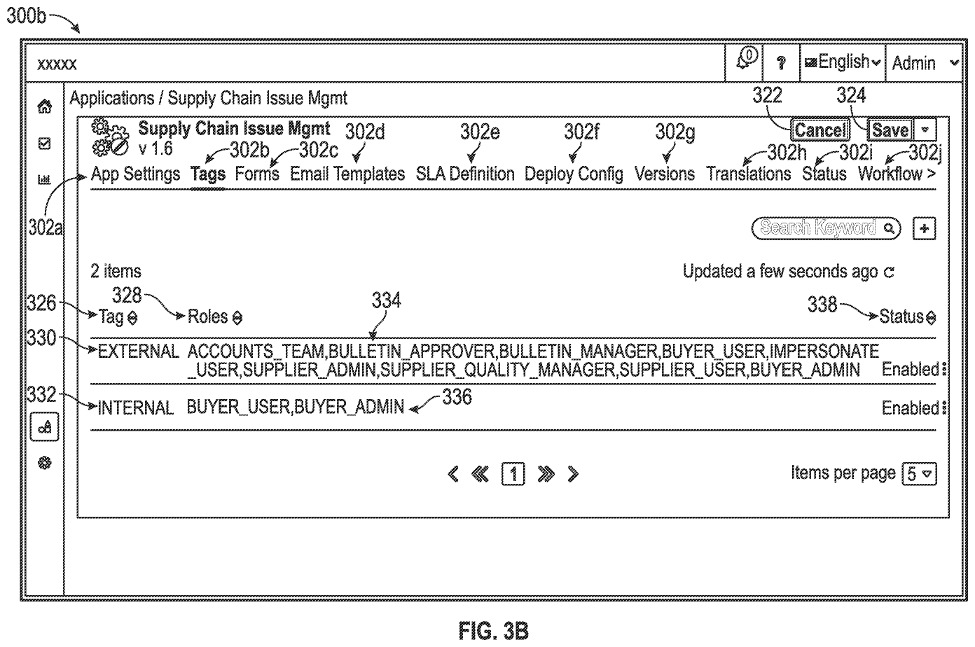

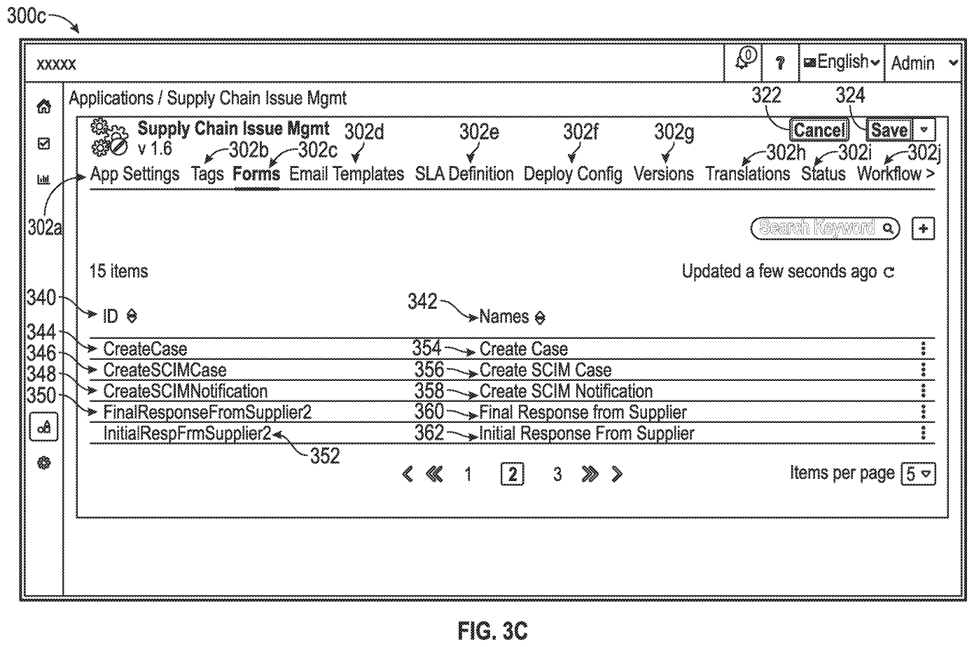

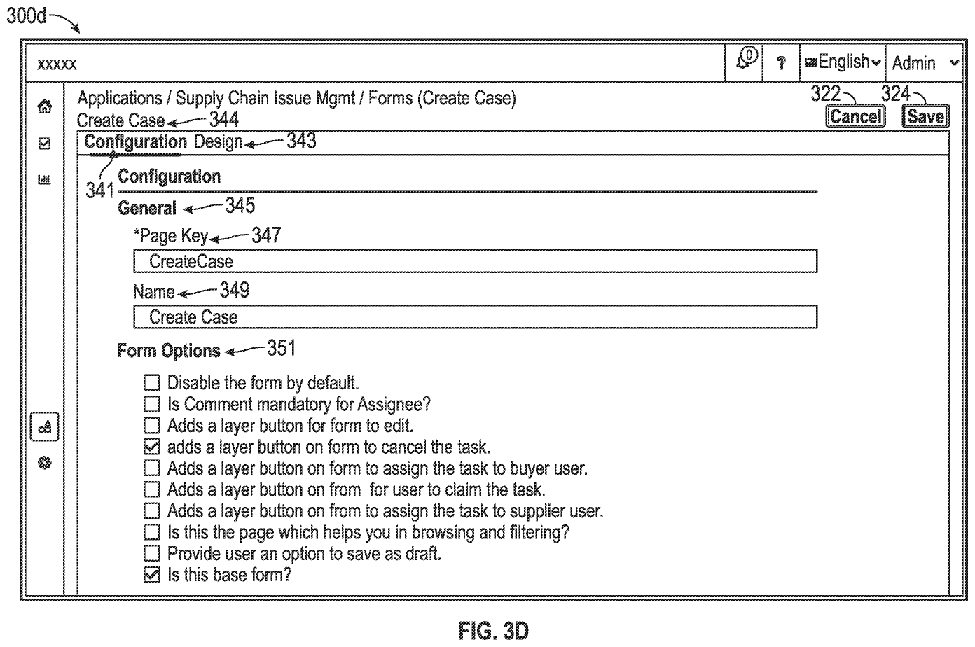

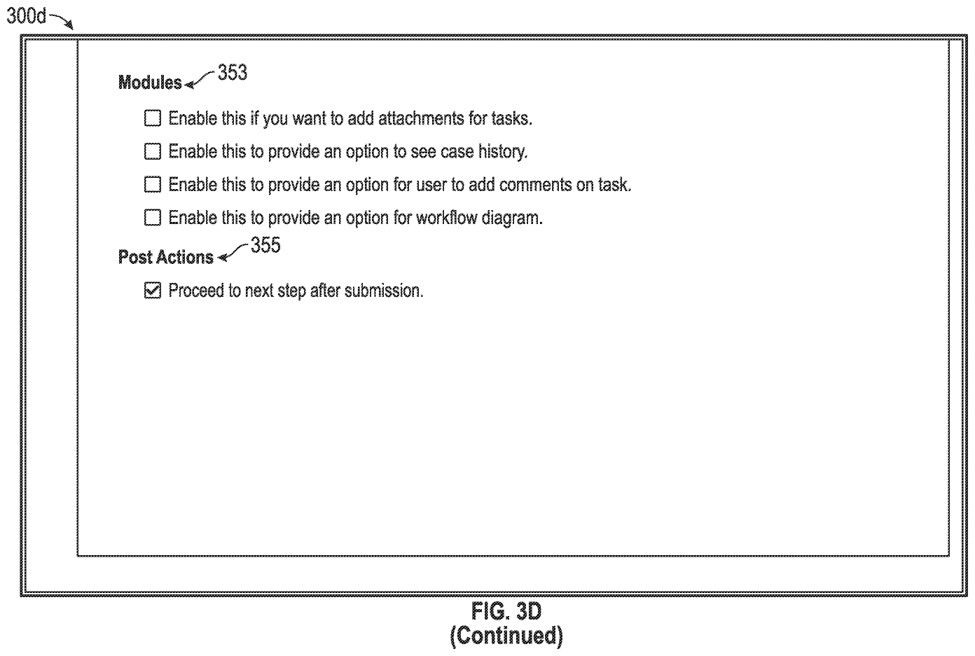

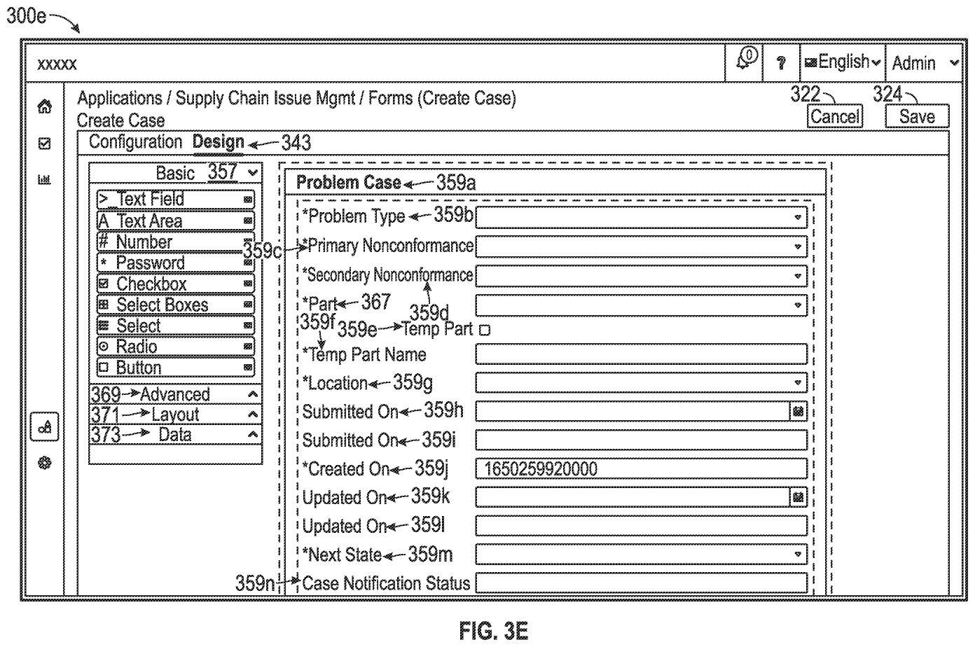

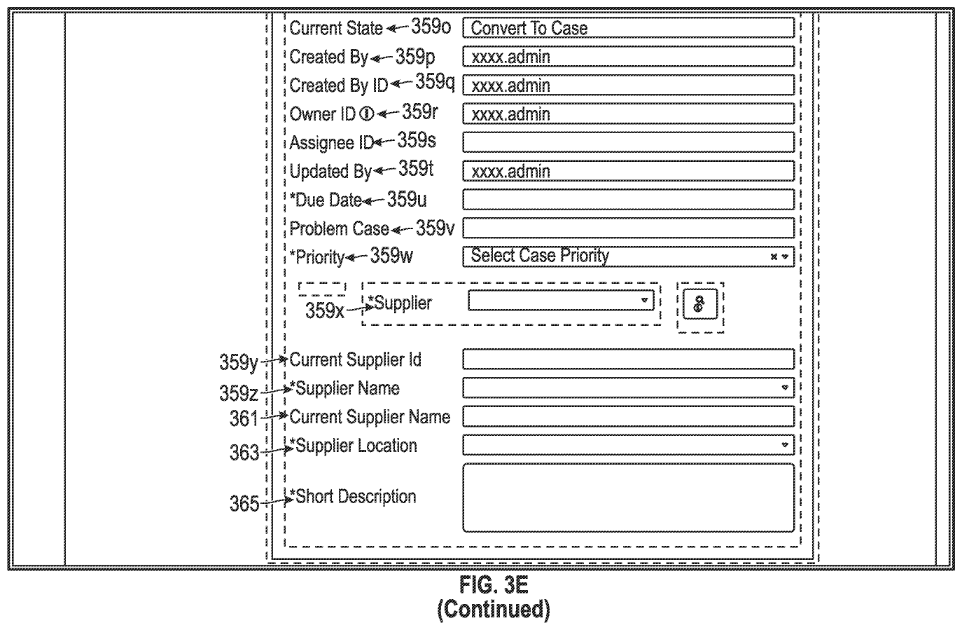

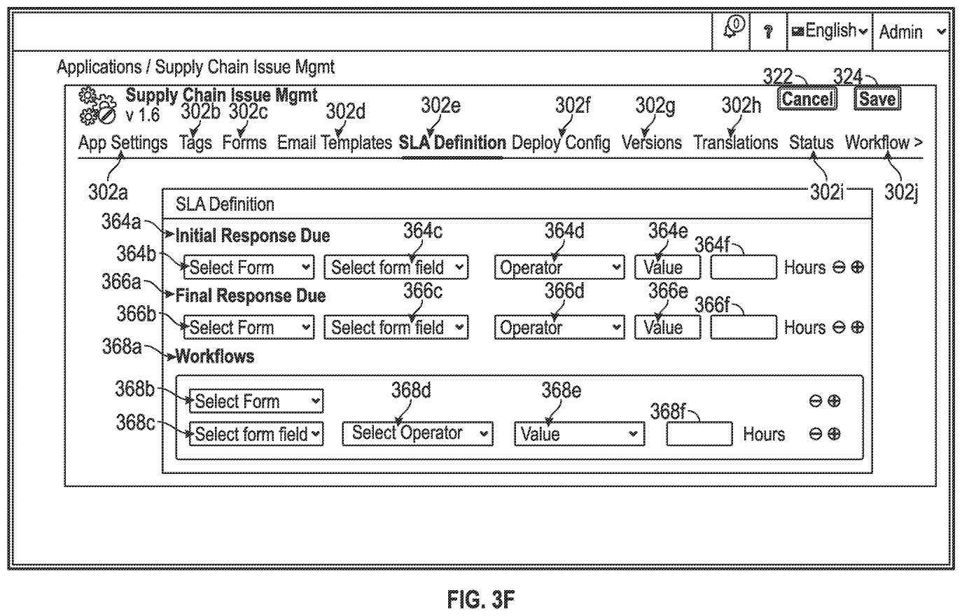

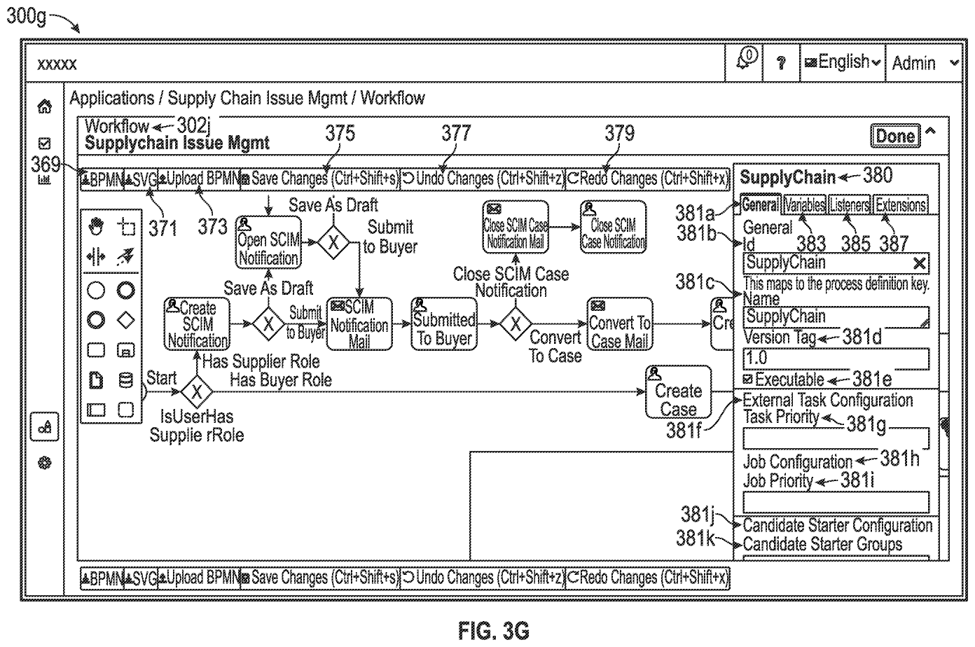

Referring to FIG. 3A is an example screen 300a depicting the settings of the dynamic workflow creation module 108, in accordance with one or more exemplary embodiments. The settings screen 300a includes settings option 302a, tags option 302b, forms option 302c, email templates option 302d, a SLA definition option 302e, a Deploy configuration option 302f, versions option 302g, translations option 302h, a status option 302i, a workflow option 302j. When the first user selects the settings option 302a, either by tapping (or double-tapping) on the settings option 302a if the interface is a touch screen, or selecting the settings option 302a by clicking (or double clicking) on the settings option 302a using a mouse. The settings screen 300a may be configured to display form elements upon selecting the settings option 302a by the first user on the first computing device 102a. The form elements may include a name option 304, a description option 306, an ID(identity) option 308, visibility roles option 310, a definition ID option 312, a sequence name option 314, a task initiator roles option 316, is supplier application check box 318, is public subscribe application check box 320. Upon selecting the name option 304 on the first computing device 102a, the name option 304 may be configured to enable the first user to enter a name (for example, supply chain issue Mgmt.). The description option 306 may be configured to enable the first user to provide the input for example: for managing supply chain issue2. The ID option 308 may be configured to enable the first user to provide the input for example: 9f548fc4-8f9c-4c80-ac3f-ddc. The visibility roles option 310 may be configured to enable the first user to provide the roles of the first user. The definition ID option 312 may be configured to enable the first user to input the definition ID. The sequence name option 314 be configured to enable the first user to input the sequence name, for example app-supply-chain-issue-mgmt, the task initiator roles option 316 may be configured to enable the first user to input the task initiator roles, for example BUYER_USER, SUPPLYER_ADMIN, SUPPLEIR USER. Is Supplier Application? check box 318 and, is Publish/Subscribe Application? check box 320 are may be radio buttons. The radio button is an option button, a graphical control element that allows the first user to select one option from a set. The cancel option 322 may be configured to enable the first user to dismiss the current screen and brings them back to their previous screen. The save option 324 may be configured to enable the user to save the input information entered by the first user.

Referring to FIG. 3B is an example screen 300b depicting a data visibility tags screen, in accordance with one or more exemplary embodiments. The data visibility tags screen 300b includes a Tag option 326, roles option 328, and status option 338. The tag option 326 includes an external option 330 and an internal option 332. The roles option 328 may include an ACCOUNTS_TEAM_APPROVER_BULLTIN_MANAGER,BUYER_USER,IMPERSANATE _USER,SUPPLIER_ADMIN,SUPPLIER_QUALITY,MANAGER_SUPPLIER role 334, and a USER_BUYER_ADMIN role 336. The status option 338 may be configured to depict the enabled status, and the disabled status. The ACCOUNTS_TEAM_APPROVER_BULLTIN_MANAGER,BUYER_USER,IMPERSANATE USER,SUPPLIER_ADMIN,SUPPLIER_QUALITY,MANAGER_SUPPLIER role 334, and the USER_BUYER_ADMIN role 336 may be the example roles.

Referring to FIG. 3C is an example screen 300c depicting form names associated with the task status, in accordance with one or more exemplary embodiments. The screen 300c includes an ID option 340, and a name option 342. The ID option 340 includes a createcase option 344, a createSCIMcase option 346, a createSCIMNotification option 348, a finalresponsefrom supplier2option 350, IntailRespFrmSupplier2 option 352. The name option 342 includes a create case option 354, a create SCIM case option 356, a create SCIM notification option 358, a FinalResponse from supplier option 360, and initial response from the supplier option 362. The forms createSCIMcase, createSCIMNotification, FinalResponse are created based on the event or state of the task. The forms createSCIMcase, createSCIMNotification, FinalResponse may represent the example status and forms associated with the status of the task. The screen 300c may be configured to display the identity and exemplary name information of the forms for the supply chain issue management on the first computing device 102a.

Referring to FIG. 3D is an example screen 300d depicting a form configuration screen, in accordance with one or more exemplary embodiments. The form configuration screen 300d may be displayed on the first computing device 102a upon selecting the createcase option 344 by the first user. The form configuration screen 300d includes a configuration option 341, and a design option 343.

Upon selecting the configuration option 341, the first user may able to view the general option 345, a form options 351, a modules option 353, a post actions option 353. The general option 345 option includes a page key bar 347, and the name option 349. The form options 351 includes multiple checkboxes. The checkboxes may be configured to enable the first user to select at least one of the checkbox or multiple checkboxes in a list. The form options 351 includes disable the form by default checkbox, is comment mandatory for assignee checkbox, adds a layer button for from to edit checkbox, adds layer button on form to cancel the task checkbox, adds a layer button on form for user to claim the task checkbox, adds a layer button on form to assign the task to supplier user checkbox, is this page which helps you in browsing and filtering? checkbox, provide user an option to save as draft checkbox, and is this base form checkbox. The modules option 353 includes enable this if you want to add attachment for tasks checkbox, enable this to provide an option to see case history checkbox, enable this to provide an option for user to add comments on task checkbox, enable this to provide an option for workflow diagram checkbox. The modules option 353 may be configured to enable the first user to select at least one option from the list of the modules option 353. The post actions 355 includes proceed to next after submission checkbox.

Referring to FIG. 3E are example screen 300e depicting a form designer screen, in accordance with one or more exemplary embodiments. The form designer 300e may be displayed on the first computing device, upon selecting the create case option 354. The screen 300e includes a basic option 357, an advanced option 369, a layout option 371, a data option 373, and a problem case option 359a. The basic option 357 includes a text field option, a text area option, a number option, a password option, a checkbox option, a select boxes option, a select option, a radio option, and a button option. The problem case 359a includes a problem type option 359b, a primary Nonconformance option 359c, a secondary nonconformance option 359d, a part option 367, a temp part tick box 359e, a temp part name option 359f, a location option 359g, a submitted on option 359h, a submitted option 359i, a created on option 359j, an updated on option 359k, an updated on option 359l, a next state option 359m, a case notifications status option 359n, a current status option 359o, a created by option 359p, a created by ID (identity) option 359q, an owner ID(Identity) option 359r, an assignee ID(identity) option 359s, an updated by option 359t, a Due date option 359u, a problem case option 359v, a priority drop down list 359w, and a supplier drop down list 359x, a current supplier ID (identity) option 359y, supplier name drop down list 359z, a current supplier name 361, a supplier location drop down list 363, short description option 365. The problem type option 359b may be configured to enable the first user to input the problem type. The primary Nonconformance option 359c may be configured to enable the first user to input the primary Nonconformance. The secondary nonconformance option 359d may be configured to enable the first user to input the secondary Nonconformance. The part option 367 may be configured to enable the first user to input the part. The temp part tick box 359e may be configured to enable the first user to input the temp part. The temp part name option 359f may be configured to enable the first user to input the temp part name. The location option 359g may be configured to enable the first user to input the location. The submitted on option 359h may be configured to enable the first user to select the date. The submitted on option 359i may be configured to enable the first user to input the date. The created on option 359j may be configured to enable the first user to input the created on, for example, 165259920000. The updated on option 359k may be configured to enable the first user to select the date. The updated on option 359l may be configured to enable the first user to input date.

The next state option 359m may be configured to enable the first user to input the next state. The case notifications status option 359n may be configured to enable the first user to input case notifications status 359n may be configured to enable the first user to input the case notifications status. The current state option 359o may be configured to enable the first user to input the current state. The created by option 359p may be configured to depict the name of the first user. The created by ID (identity) option 359q may be configured to depict the ID(identity) of the first user. The owner ID(Identity) option 359r may be configured to depict the owner ID(Identity). The assignee ID(identity) option 359s may be configured to enable the first user to input the assignee ID(Identity). The updated by option 359t may be configured to depict the updated data. The Due date option 359u may be configured to enable the first user to input the due date. The problem case 359v may be configured to enable the first user to input the problem case. The priority drop down list 359w may be configured to enable the first user to select the required option from the priority drop down list 359w. The supplier drop down list 359x may be configured to enable the first user to select a required option from the supplier drop down list. The current supplier ID option 359y may be configured to enable the first user to input the current supplier ID. The supplier name drop down list 359z may be configured to enable the first user to select a required option from the supplier name drop down list. The current supplier name 361 may be configured to enable the first user to input the current supplier name. The supplier location drop down list 363 may be configured to enable the first user to select the required input from the supplier location drop down list. The short description option 365 may be configured to enable the first user to write the short description.

Referring to FIG. 3F is an example screen 300f depicting a SLA (service-level agreement) definition screen, in accordance with one or more exemplary embodiments. The SLA definition screen 300f may be displayed on the first computing device 102a upon selecting the SLA (service-level agreement) definition option 302e. The SLA (service-level agreement) definition option 302e includes an initial response due option 364a, a final response due option 366a, and a workflows option 368a. Further, the initial response due option 364a includes a select form drop-down list 364b, a select form field drop-down list 364c, an operator drop-down list 364d, a value option 364e, and hours option 364f. The select form drop-down list 364b, the select form field drop-down list 364c, and the operator drop-down list 364d may be configured to enable the first user to select the form, the form field, and the operator from the drop-down list. The value option 364e, and the hour's option 364f may be configured to enable the first user to input the value and hours to create the initial response.

The final response due option 366a includes a select form drop-down list 366b, a select form field drop-down list 366c, an operator drop-down list 366d, and a value option 366e, an hours option 366f. The select form drop-down list 366b, the select form field drop-down list 366c, and the operator drop-down list 366d may be configured to enable the first user to select the form, the form field, and the operator from the drop-down list. The value option 366e, and the hour's option 366f may be configured to enable the first user to input the value and hours to create the final response.

The workflows option 368a includes a select form drop-down list option 368b, a select form field option 368c, a select operator option 368d, a value option 368e, an hours option 368f. The select form drop-down list option 368b, the select form field option 368c, the select operator 368d may be configured to enable the first user to select the form, the form field, and the operator from the drop-down list. The value option 368e, and the hour's option 368f may be configured to enable the first user to input the value and hours to create workflows.

Referring to FIG. 3G is an example screen 300g depicting a workflow designer screen, in accordance with one or more exemplary embodiments. The workflow designer screen 300g may be displayed on the first computing device 102a upon selecting the workflow option 302j. The workflow designer screen 300g includes a BPMN option 369, a SYG option 371, and upload BPMN option 373, a save changes option 375, and undo changes option 377, a redo changes option 379, and a supply chain option 380. Further, the supply chain option 380 includes a general option 381a, a variables option 383, a listener's option 385, and an extensions option 387. Upon selecting the general option 381a, the workflow designer screen 300g may be configured to display an ID option 381b, a name option 381c, a version tag option 381d, an executable check box 381e, an external task configuration option 381f, a job configuration option 381h, a candidate starter configuration option 381j. The ID option 381b may be configured to enable the first user to input the identity of the supply chain. The name option 381c may be configured to enable the first user to input the name. The version tag option 381d may be configured to enable the first user to input the version tag. The executable check box 381e may be configured to enable the first user to select or deselect the checkbox. The external task configuration option 381f includes a task priority option 381g that may be configured to enable the first user to select the priority task. The job configuration option 381h includes a job priority option 381i configured to enable the first user to select the job priority. The candidate starter configuration option 381j includes the candidate starter groups option 381k may be configured to enable the first user to select the candidate starter groups.

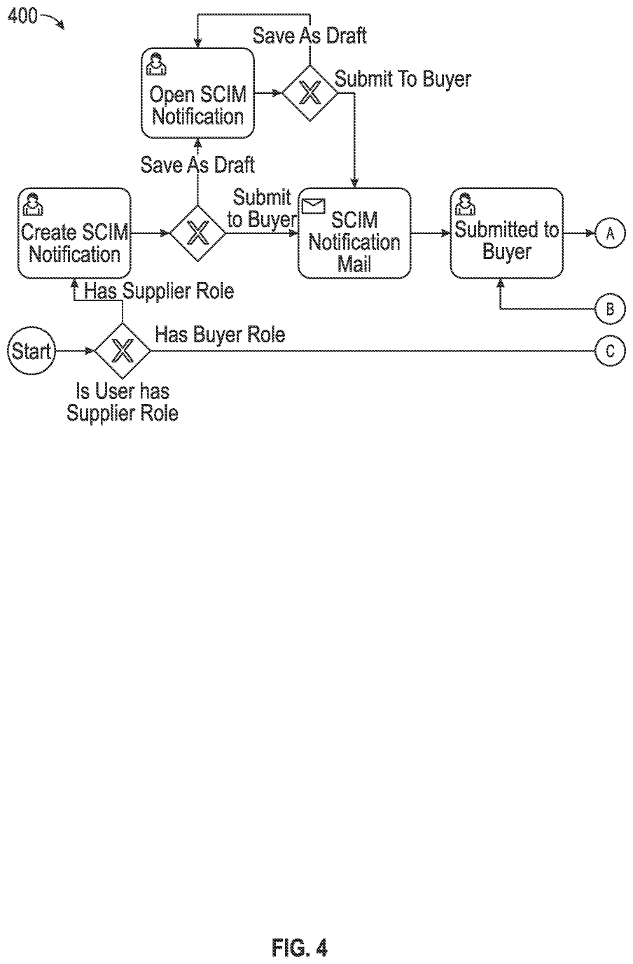

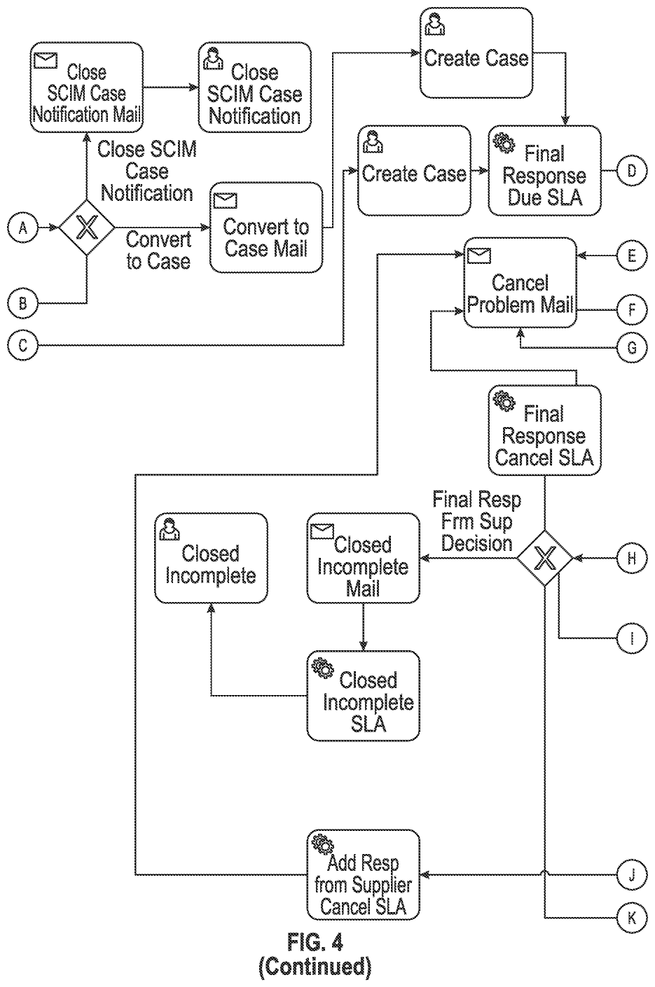

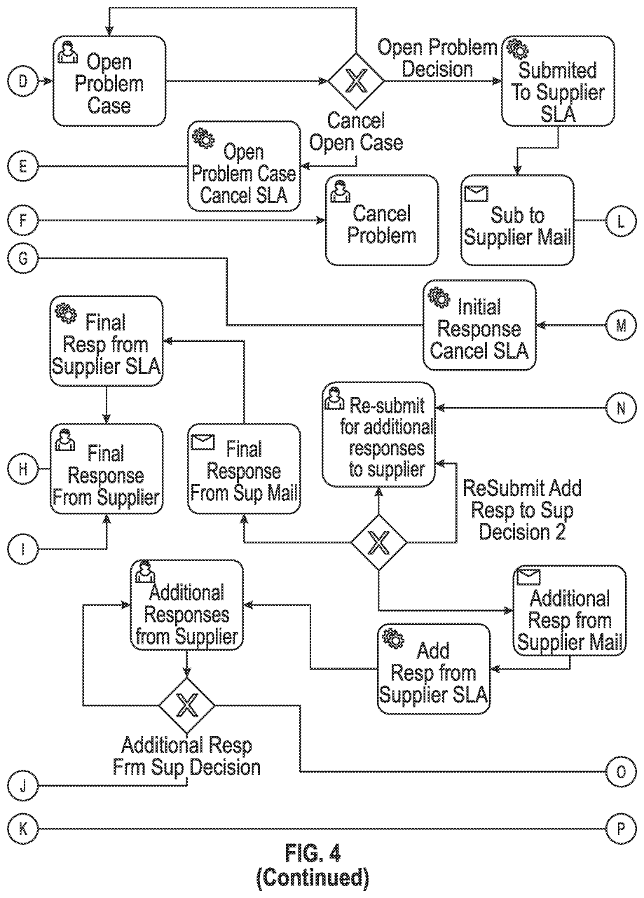

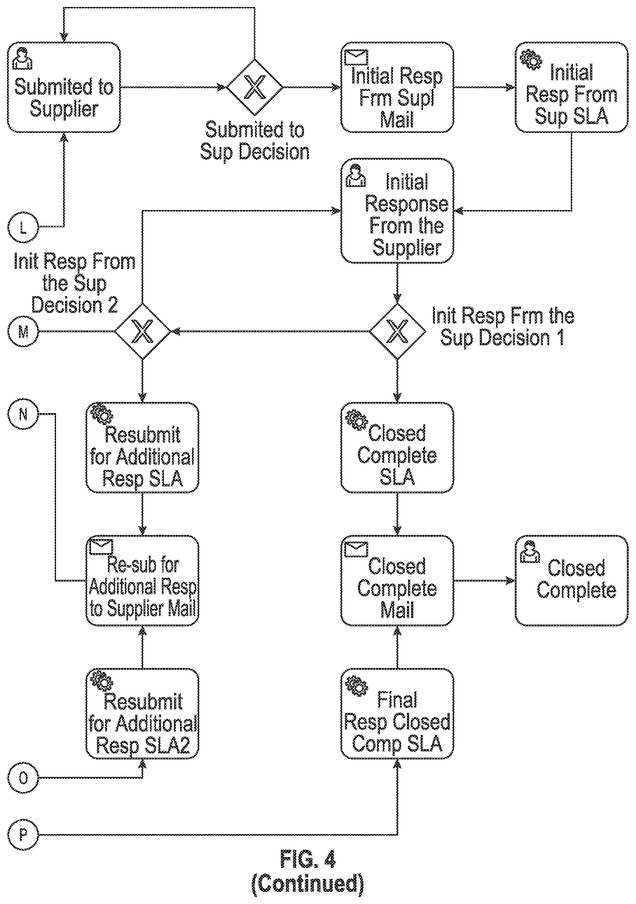

Referring to FIG. 4 is an example diagram 400 depicting a workflow of the dynamic workflow creation module, in accordance with one or more exemplary embodiments. The diagram 400 represents the visual form of the design business processes, and decision model configuration made using the workflow designer 204. The workflow designer 204 may be configured to enable the first user to add/delete/modify the elements in the diagram with a drag and drop interface. The created dynamic workflow may be persisted in the Config DB (first database 112).

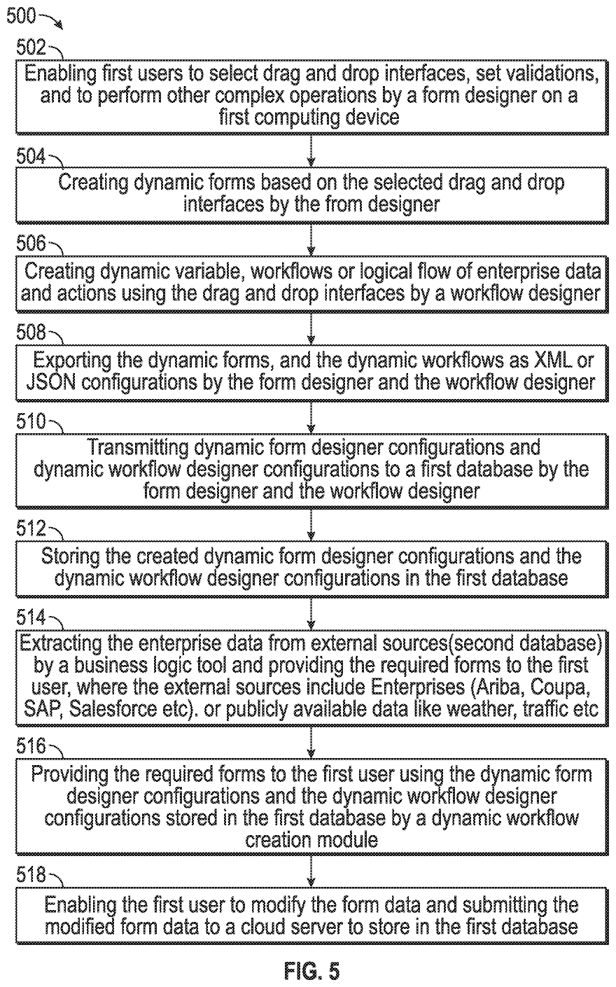

Referring to FIG. 5 is a flow diagram 500 depicting a method for creating dynamic workflows to address the needs of the supply chain, in accordance with one or more exemplary embodiments. The method 500 may be carried out in the context of the details of FIG. 1, FIG. 2, FIG. 3A, FIG. 3B, FIG. 3C, FIG. 3D, FIG. 3E, FIG. 3F, FIG. 3G, and FIG. 4. However, the method 500 may also be carried out in any desired environment. Further, the aforementioned definitions may equally apply to the description below.

The method commences at step 502, enabling the first user to select drag and drop interfaces, set validations, and to perform other complex operations by the form designer on the first computing device. Thereafter, at step 504, creating dynamic forms based on the selected drag and drop interfaces. Thereafter, at step 506, creating dynamic variables, workflows or logical flow of enterprise data and actions using the drag and drop interfaces by the workflow designer. Thereafter, at step 508, exporting the dynamic forms and the dynamic workflows as XML or JSON configurations by the form designer and the workflow designer, the one or more XML configurations include the dynamic form designer configurations and the dynamic workflow designer configurations. Thereafter, at step 510, transmitting the dynamic form designer configurations and the dynamic workflow designer configurations to the first database by the form designer and the workflow designer. Thereafter, at step 512, storing the created dynamic form designer configurations and the dynamic workflow designer configurations in the first database. Thereafter at step 514, extracting the enterprise data from the external sources(second database) by the business logic tool and providing the required forms to the first user, where external sources include Enterprises (Ariba, Coupa, SAP, Salesforce, etc.). or publicly available data like weather, traffic, etc. Thereafter at step 516, providing the required forms to the first user using the one or more dynamic form designer configurations and the one or more dynamic workflow designer configurations stored in the first database by the dynamic workflow creation module. Thereafter, at step 518, enabling the first user to modify the form data and submit the modified form data to the cloud server thereby storing in the first database.

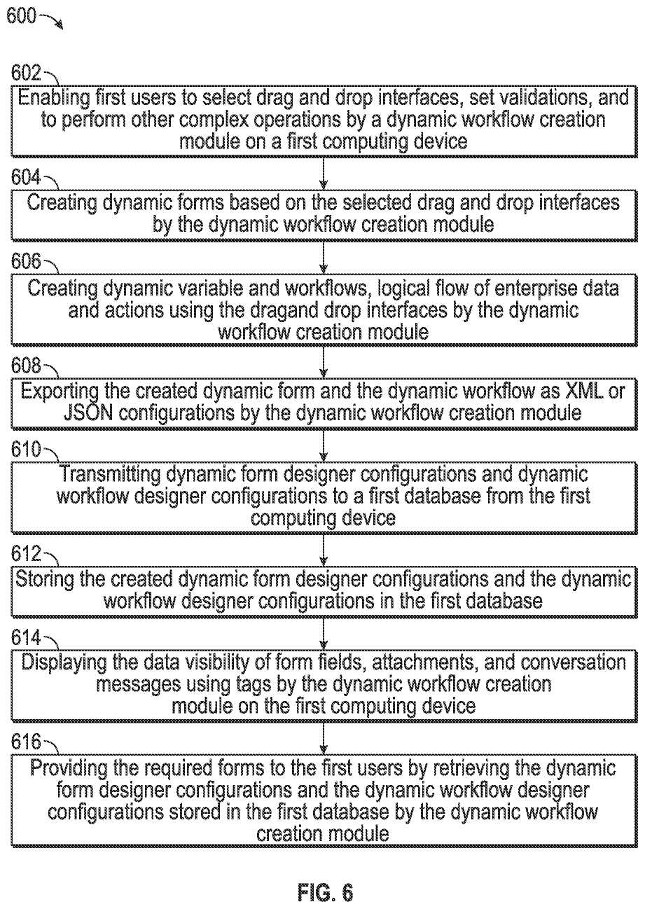

Referring to FIG. 6 is a flow diagram 600 depicting a method for creating dynamic workflows, in accordance with one or more exemplary embodiments. The method 600 may be carried out in the context of the details of FIG. 1, FIG. 2, FIG. 3A FIG. 1, FIG. 2, FIG. 3A, FIG. 3B, FIG. 3C, FIG. 3D, FIG. 3E, FIG. 3F, FIG. 3G, and FIG. 4, and FIG. 5. However, the method 600 may also be carried out in any desired environment. Further, the aforementioned definitions may equally apply to the description below.

The method commences at step 602, enabling first users to select drag and drop interfaces, set validations, and to perform other complex operations by the dynamic workflow creation module on the first computing device. Thereafter, at step 604, creating dynamic forms based on the selected drag and drop interfaces by the dynamic workflow creation module. Thereafter, at step 606, creating dynamic variables and workflows, logical flow of enterprise data and actions using the drag and drop interfaces by the dynamic workflow creation module. Thereafter, at step 608, exporting the created dynamic form and the dynamic workflow as XML or JSON configurations by the dynamic workflow creation module. Thereafter, at step 610, transmitting the dynamic form designer configurations and the dynamic workflow designer configurations to the first database from the first computing device. Thereafter, at step 612, storing the created dynamic form designer configurations and the dynamic workflow designer configuration in the first database. Thereafter, at step 614, displaying the data visibility of form fields, attachments, and conversation messages using tags by the dynamic workflow creation module on the first computing device. Thereafter at step 616, providing the required forms to the first users by retrieving the dynamic form designer configurations and the dynamic workflow designer configurations stored in the first database by the dynamic workflow creation module.

Referring to FIG. 7 is a block diagram 700 illustrating the details of a digital processing system 700 in which various aspects of the present disclosure are operative by execution of appropriate software instructions. The Digital processing system 700 may correspond to the first computing device 102a or second computing device 102b (or any other system in which the various features disclosed above can be implemented).

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions, such as those used in threads and stacks, constituting shared environment 725 and/or user programs 726. Shared environment 725 includes operating systems, device drivers, virtual machines, etc., which provide a (common) run time environment for execution of user programs 726.

Graphics controller 760 generates display signals (e.g., in RGB format) to display unit 770 based on data/instructions received from CPU 710. Display unit 770 contains a display screen to display the images defined by the display signals. Input interface 790 may correspond to a keyboard and a pointing device (e.g., touch-pad, mouse) and may be used to provide inputs. Network interface 780 provides connectivity to a network (e.g., using Internet Protocol), and may be used to communicate with other systems (such as those shown in FIG. 1) connected to the network 110.

Secondary memory 730 may contain hard drive 735, flash memory 736, and removable storage drive 737. Secondary memory 730 may store the data software instructions (e.g., for performing the actions noted above with respect to the Figures), which enable digital processing system 700 to provide several features in accordance with the present disclosure.

Some or all of the data and instructions may be provided on removable storage unit 740, and the data and instructions may be read and provided by removable storage drive 737 to CPU 710. Floppy drive, magnetic tape drive, CD-ROM drive, DVD Drive, Flash memory, removable memory chip (PCMCIA Card, EEPROM) are examples of such removable storage drive 737.

Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 750. Transmission media can also take the form of acoustic or light waves, such as those generated during radio-wave and infra-red data communications.

According to exemplary embodiments of the present disclosure, a computer-implemented system for creating dynamic workflows to address the needs of a supply chain, comprising a first computing device 102a comprising a processor 104, a memory 106 and a dynamic workflow creation module 108, wherein the processor 104 coupled with the memory 106 configured to store the workflow creation module 108, the processor 104 configured to respond to one or more user inputs performed by one or more first users on the first computing device 102a; the dynamic workflow creation module 108 comprising a form designer 202 configured to enable the one or more first users to select one or more drag and drop interfaces, set validations, and perform one or more complex operations on the first computing device 102a, whereby the form designer 202 configured to create one or more dynamic forms based on the one or more drag and drop interfaces selected by the one or more users on the first computing device 102a.

According to another exemplary embodiments of the present disclosure, a workflow designer 204 configured to define an enterprise data and create a logical flow of data and actions, the workflow designer 204 configured to create a dynamic variable and one or more dynamic workflows based on the one or more drag and drop interfaces selected by the one or more first users on the first computing device 102a, whereby the form designer 202 and the workflow designer 204 are configured to export the one or more dynamic forms, the dynamic variable and the one or more dynamic workflows as one or more XML configurations, the one or more XML configurations comprises one or more dynamic form designer configurations and one or more dynamic workflow designer configurations.

According to another exemplary embodiments of the present disclosure, the form designer 202 and the workflow designer 204 configured to transmit the one or more dynamic form designer configurations and the one or more dynamic workflow designer configurations to a first database from the first computing device 102a over a network 110, whereby the first database 112 configured to store the one or more dynamic form designer configurations and the one or more dynamic workflow designer configurations.

According to another exemplary embodiments of the present disclosure, a business logic tool 206 configured to receive the one or more dynamic form designer configurations, the one or more dynamic workflow designer configurations and form filled data from the form designer 202 and the workflow designer 204, whereby the business logic tool 206 configured to transmit the one or more form designer configurations, one or more workflow configurations and form filled data to the first database 112 and stores the one or more form designer configurations, the one or more workflow configurations and the form filled data.

According to another exemplary embodiments of the present disclosure, the business logic tool 206 configured to provide one or more required forms to the one or more first users using the one or more form designer configurations, the one or more workflow configurations and the form filled data stored in the first database 112, the business logic tool 206 also configured to extract the enterprise data from a second database 114 to provide the one or more required forms to the one or more first users when the one or more required forms are not available in the first database 112.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A computer-implemented system for creating dynamic workflows to address the needs of a supply chain, comprising:
a first computing device comprising a processor, a memory, and a dynamic workflow creation module, wherein the processor coupled with the memory configured to store the workflow creation module, the processor configured to respond to one or more user inputs performed by one or more first users on the first computing device;
the dynamic workflow creation module comprising a form designer configured to enable the one or more first users to select one or more drag and drop interfaces, set validations, and perform one or more complex operations on the first computing device, whereby the form designer configured to create one or more dynamic forms based on the one or more drag and drop interfaces selected by the one or more users on the first computing device;
a workflow designer configured to define an enterprise data and create a logical flow of data and actions, the workflow designer configured to create a dynamic variable and one or more dynamic workflows based on the one or more drag and drop interfaces selected by the one or more first users on the first computing device, whereby the form designer and the workflow designer are configured to export the one or more dynamic forms, the dynamic variable and the one or more dynamic workflows as one or more XML or JSON configurations, the one or more XML or JSON configurations comprises one or more dynamic form designer configurations and one or more dynamic workflow designer configurations;
the form designer and the workflow designer configured to transmit the one or more dynamic form designer configurations and the one or more dynamic workflow designer configurations to a first database and a business logic tool from the first computing device over a network, whereby the first database configured to store the one or more dynamic form designer configurations and the one or more dynamic workflow designer configurations;
the business logic tool configured to receive the one or more dynamic form designer configurations, the one or more dynamic workflow designer configurations and form filled data from the form designer and the workflow designer, whereby the business logic tool configured to transmit the one or more form designer configurations, one or more workflow configurations and form filled data to the first database and stores the one or more form designer configurations, the one or more workflow configurations and the form filled data in the first database; and
the business logic tool configured to provide one or more required forms to the one or more first users by retrieving the one or more form designer configurations, the one or more workflow configurations and the form filled data stored in the first database, the business logic tool also configured to extract the enterprise data from a second database to provide the one or more required forms to the one or more first users when the one or more required forms are not available in the first database.

2. The system of claim 1, wherein the second database comprising one or more external data sources.

3. The system of claim 2, wherein the one or more external data sources comprising one or more enterprises and/or publicly available data like weather, and traffic.

4. The system of claim 3, wherein the one or more external enterprises in the second database comprising Ariba, Coupa, SAP, and Salesforce.

5. The system of claim 1, wherein the form designer is configured to create web-based forms with HTML5 UI elements.

6. The system of claim 1, wherein the business logic tool is a business process modelling notation (BPMN) tool which is intelligent in obtaining the enterprise data available from the one or more external data sources and manages the flow of data.

7. The system of claim 1, wherein the dynamic workflow creation module comprising a drag and drop operations module is configured to enable the one or more first users to select the one or more required drag and drop interfaces to create the one or more dynamic workflow.

8. The system of claim 1, wherein the dynamic workflow creation module comprising a workflow designing, deploying, and executing module is configured to enable the one or more first users to design, deploy, and execute trade workflows with the business logic tool to address the needs of the second users.

9. The system of claim 1, wherein the dynamic workflow creation module comprising an event triggering module is configured to address extended and complex trading scenarios with a variable due date, event triggers and alert mechanisms.

10. The system of claim 9, wherein the event triggers and alert mechanism comprising messages, SMS, and email notifications, multi-lingual, ready APIs integrated.

11. The system of claim 1, wherein the dynamic workflow creation module comprising a data accessing module is configured to access enterprise data easily from the second database to create the one or more dynamic workflows.

12. The system of claim 1, wherein the dynamic workflow creation module comprising a workflows modification module is configured to enable the one or more first users to modify and deploy the business workflows as per changing business needs without any internal code changes.

13. The system of claim 1, wherein the dynamic workflow creation module comprising an alliance execution module is configured to perform intelligent enterprise alliances and realizes a trading partner's business logic through the dynamic workflow designer configurations and the dynamic form designer configurations.

14. The system of claim 13, wherein the alliance execution module eventually makes the enterprise data available from the one or more external data sources and manages the flow of data for the alliance execution.

15. The system of claim 1, wherein the dynamic workflow creation module comprising an attachments and conversations creating module is configured to create one or more attachments and conversations for a task, where the one or more first users and the one or more second users collaborate exchanging messages and documents between the first computing device and a second computing device.

16. The system of claim 1, wherein the dynamic workflow creation module comprising a tag allocating module is configured to allocate one or more tags for the data visibility of form fields/attachments/conversation messages and the like.

17. A method for creating dynamic workflows to address the needs of a supply chain, comprising:
enabling one or more first users to select one or more drag and drop interfaces, set validations, and perform one or more complex operations on a first computing device;
creating one or more dynamic forms by a form designer based on the one or more drag and drop interfaces selected by the one or more first users on the first computing device;
creating a logical flow of data and actions, a dynamic variable and one or more dynamic workflows by a workflow designer based on the one or more drag and drop interfaces selected by the one or more first users on the first computing device,
exporting the one or more dynamic forms, the dynamic variable and the one or more dynamic workflows as one or more XML configurations by the form designer and the workflow designer, the one or more XML configurations comprises one or more dynamic form designer configurations and one or more dynamic workflow designer configurations;
transmitting the one or more dynamic form designer configurations and the one or more dynamic workflow designer configurations to a first database and a business logic tool by the form designer and the workflow designer;
storing the one or more dynamic form designer configurations and the one or more dynamic workflow designer configurations in the first database;
receiving the one or more dynamic form designer configurations, the one or more dynamic workflow designer configurations and form filled data from the form designer and the workflow designer by the business logic tool;
transmitting the one or more form designer configurations, one or more workflow configurations and form filled data to the first database and storing the one or more form designer configurations, the one or more workflow configurations and the form filled data in the first database; and
providing one or more required forms to the one or more first users using the one or more form designer configurations, the one or more workflow configurations and the form filled data stored in the first database.

18. The method of claim 17, comprising a step of creating one or more web-based forms with HTML5 UI elements.

19. The method of claim 17, comprising a step of obtaining the enterprise data available from the one or more external data sources and manages the flow of data by a business process modelling notation (BPMN) tool.

20. The method of claim 17, comprising a step of enabling the one or more first users to select the one or more required drag and drop interfaces to create the one or more dynamic workflow by a drag and drop operations module.

21. The method of claim 17, comprising a step of enabling the one or more first users to design, deploy, and execute trade workflows with the business logic tool to address the needs of the second users by a workflow designing, deploying, and executing module.

22. The method of claim 17, comprising a step of addressing extended and complex trading scenarios with a variable due date, event triggers and alert mechanisms by an event triggering module.

23. The method of claim 17, comprising a step of accessing enterprise data easily from the second database to create the one or more dynamic workflows by a data accessing module.

24. The method of claim 17, comprising a step of enabling the one or more first users to modify and deploy the business workflows as per changing business needs without any internal code changes by a workflow modification module.

25. The method of claim 17, comprising a step of performing intelligent enterprise alliances and realizes a trading partner's business logic through the dynamic workflow designer configurations and the dynamic form designer configurations by an alliance execution module.

26. The method of claim 25, comprising a step of eventually making the enterprise data available from the one or more external data sources and managing the flow of data for the alliance execution by the alliance execution module.

27. The method of claim 17, comprising a step of creating one or more attachments and conversations for a task by an attachments and conversations creating module, where the one or more first users and the one or more second users collaborate exchanging messages and documents between the first computing device and a second computing device.

28. The method of claim 17, comprising a step of allocating one or more tags for the data visibility of form fields/attachments/conversation messages and the like a tag allocating module.

29. A computer program product comprising a non-transitory computer-readable medium having a computer-readable program code embodied therein to be executed by one or more processors, said program code including instructions to:
enable one or more first users to select one or more drag and drop interfaces, set validations, and perform one or more complex operations on a first computing device;
create one or more dynamic forms by a form designer based on the one or more drag and drop interfaces selected by the one or more first users on the first computing device;
create a logical flow of data and actions, a dynamic variable and one or more dynamic workflows by a workflow designer based on the one or more drag and drop interfaces selected by the one or more first users on the first computing device,
export the one or more dynamic forms, the dynamic variable and the one or more dynamic workflows as one or more XML configurations by the form designer and the workflow designer, the one or more XML configurations comprises one or more dynamic form designer configurations and one or more dynamic workflow designer configurations;
transmit the one or more dynamic form designer configurations and the one or more dynamic workflow designer configurations to a first database by the form designer and the workflow designer;
receive the one or more dynamic form designer configurations, the one or more dynamic workflow designer configurations and form filled data from the form designer and the workflow designer by the business logic tool;
transmit the one or more form designer configurations, one or more workflow configurations and form filled data to the first database and storing the one or more form designer configurations, the one or more workflow configurations and the form filled data in the first database; and
provide one or more required forms to the one or more first users using the one or more form designer configurations, the one or more workflow configurations and the form filled data stored in the first database.
